(19) United States
(12) Patent Application Publication
(10) Pub. No.: US 2026/0003100 A1
(43) Pub. Date: Jan. 1, 2026

(54) MULTI-MODEL BLENDING OF PROBABILISTIC WEATHER FORECASTS

(71) Applicant: Salient Predictions, Inc., Cambridge, MA (US)

(72) Inventors: Samuel James Levang, Malden, MA (US); Fran Bartolic, New York, NY (US)

(73) Assignee: Salient Predictions, Inc., Cambridge, MA (US)

(21) Appl. No.: 19/250,870

(22) Filed: Jun. 26, 2025

Related U.S. Application Data
(60) Provisional application No. 63/665,658, filed on Jun. 28, 2024.

(51) Int. Cl. G01W 1/10; G06N 20/00

(52) U.S. Cl. CPC G01W 1/10; G06N 20/00

(57) ABSTRACT

Multi-model blending of probabilistic weather forecasts is described. A system segments a first training data set into a plurality of second training data sets each including corresponding subsets of a first output of a first probabilistic model and a second output of a second probabilistic model. The system modifies, for each of the subsets, weights of a machine learning model with. The system generates a control parameter indicative of alignment of the machine learning model with one or more of the plurality of second training data sets, and provides, responsive to the control parameter satisfying a threshold indicative of a level of alignment with the plurality of second training data sets, the machine learning model trained to generate, according to the one or more weights, a weighted output of the first probabilistic model and the second probabilistic model at the first point and the second point.

### CROSS-REFERENCES TO RELATED APPLICATIONS

This application claims the benefit of priority under 35 U.S.C. § 119 to U.S. Provisional Patent Application No. 63/665,658, filed Jun. 28, 2024, which is hereby incorporated by reference herein in its entirety.

### BACKGROUND

It can be technically challenging to accurately predict, and provide advanced notice of, particular climatological events and conditions. For example, with the increase in the likelihood of terrestrial climatological events and conditions beyond expected boundaries, it is both increasingly technically challenging and important to identify weather conditions for a given day with greater advance notice than seven or ten days. However, conventional systems cannot effectively generate accurate estimates of future climatological events and conditions with sufficient accuracy.

### SUMMARY

Weather forecasting, particularly for sub-seasonal to seasonal lead times can present technical challenges regarding reliability, accuracy, and the calibration of probabilistic outputs, particularly when integrating results from heterogeneous forecast models. Some aggregation methods may rely on static or globally fixed weights to blend outputs from constituent weather models, making it difficult to account for local, temporal, and seasonal variations. As a result, the forecasts produced by such techniques may have a reduced accuracy, poorly characterized uncertainty, and consistency issues, including crossing quantiles or mis-calibrated probability distributions. As a result, it may be beneficial to provide a probabilistic weather forecasting system that can dynamically adjust model combination weights based on attributes such as location, forecast lead time, season, and the prevailing climate state, while simultaneously preserving the statistical consistency and interpretability of the resulting forecasts.

The technical solutions of this disclosure overcome these challenges by providing an approach for dynamically generating highly accurate and calibrated probabilistic weather forecasts accounting for local, temporal, and seasonal variations. The technical solutions can segment historical forecast data from multiple probabilistic weather models into targeted training subsets and utilize a machine learning blender model that assigns adaptive blending weights to each constituent model for each subset. The adaptive weights can be determined based on relevant forecast attributes such as location, lead time, and season. During model training, overall forecast skill is optimized using a control parameter, such as a probabilistic loss function, while consistency constraints, such as non-crossing of quantile levels and normalization of weights, can be enforced. At runtime, the learned blender model can combine the outputs from multiple probabilistic models to produce an aggregate probabilistic forecast for a specified location and forecast period, thereby improving the reliability and interpretability of probabilistic weather prediction.

Aspects of the technical solutions described herein are directed to a blender model utilizing a machine learning architecture designed to predict weather conditions at specific locations for future times ranging, for example, from two weeks to up to one year ahead. The described technical solutions include training a machine learning model to forecast weather conditions at a given location up to one year in advance. An aspect of these solutions involves using a machine learning pipeline to train and validate a blender model (e.g., a multi-model blending system) to take as input multiple weather model forecasts, and combine them into a single optimal forecast. To do so, the blender model can appropriately weight outputs from multiple probabilistic weather models, ultimately generating a weighted prediction for various geographic locations (such as grid points on a map). This output can represent a probabilistic assessment of the likelihood of certain weather conditions at a location, derived from blending input probabilistic models according to machine-learned weights. As a result, the technical solution described herein offers a technical advancement in producing accurate weather forecasts well beyond two weeks ahead, potentially on a seasonal basis, while remaining applicable for forecasts over shorter lead times from one day to two weeks. Additionally, the machine learning model, according to an aspect of this solution, can be trained to maintain a consistent set of weights corresponding to forecast lead times, geographic details, or seasonal periods. Consequently, this innovation enhances the ability of a machine learning model blending multiple probabilistic weather models to provide accurate forecasts for both long-range and shorter-range scenarios.

At least one aspect of the technical solutions described herein can be directed to a system. The system can include one or more processors, coupled with memory. The system can segment a first training data set into a plurality of second training data sets each can include corresponding subsets of a first output of a first probabilistic model and a second output of a second probabilistic model, the first output can include a first forecast indicative of a weather condition, and the second output can include a second forecast indicative of the weather condition. The system can modify, for each of the subsets, one or more weights of a machine learning model with input can include a first point of each of the plurality of second training data sets and a second point of each of the plurality of second training data sets, the first point indicative of the weather condition at a location, and the second point indicative of the weather condition at 200a time corresponding to the location. The system can generate a control parameter indicative of alignment of the machine learning model with one or more of the plurality of second training data sets. The system can provide, responsive to the control parameter satisfying a threshold indicative of a level of alignment with the plurality of second training data sets, the machine learning model trained to generate, according to the one or more weights, a weighted output of the first probabilistic model and the second probabilistic model at the first point and the second point.

At least one aspect of the technical solutions described herein can be directed to a system. The system can obtain a runtime data set, can include a first output of a first probabilistic model and a second output of a second probabilistic model, the first output can include a first forecast indicative of the weather condition, and the second output can include a second forecast indicative of the weather condition. The system can generate, according to a machine learning model having one or more weights and receiving as input the runtime data set, a weighted output of the first probabilistic model and the second probabilistic model at a first target point indicative of a location and a second target point indicative of a time corresponding to the location, where the one or more weights each correspond to one or more first training points corresponding to the first target point and one or more second training points corresponding to the second target point, each of the first training points indicative of the weather condition at one or more locations, and each of the one or more second training points indicative of the weather condition at one or more times respectively corresponding to the one or more locations.

At least one aspect of the technical solutions described herein can be directed to a method. The method can include segmenting a first training data set into a plurality of second training data sets each can include corresponding subsets of a first output of a first probabilistic model and a second output of a second probabilistic model, the first output can include a first forecast indicative of a weather condition, and the second output can include a second forecast indicative of the weather condition. The method can include modifying, for each of the subsets, one or more weights of a machine learning model with input can include a first point of each of the plurality of second training data sets and a second point of each of the plurality of second training data sets, the first point indicative of the weather condition at a location, and the second point indicative of the weather condition at a time corresponding to the location. The method can include generating a control parameter indicative of alignment of the machine learning model with one or more of the plurality of second training data sets. The method can include providing, responsive to the control parameter satisfying a threshold indicative of a level of alignment with the plurality of second training data sets, the machine learning model trained to generate, according to the one or more weights, a weighted output of the first probabilistic model and the second probabilistic model at the first point and the second point.

At least one aspect of the technical solutions described herein can be directed to a method. The method can include obtaining a runtime data set, can include a first output of a first probabilistic model and a second output of a second probabilistic model, the first output can include a first forecast indicative of the weather condition, and the second output can include a second forecast indicative of the weather condition. The method can include generating, according to a machine learning model having one or more weights and receiving as input the runtime data set, a weighted output of the first probabilistic model and the second probabilistic model at a first target point indicative of a location and a second target point indicative of a time corresponding to the location, where the one or more weights each correspond to one or more first training points corresponding to the first target point and one or more second training points corresponding to the second target point, each of the first training points indicative of the weather condition at one or more locations, and each of the one or more second training points indicative of the weather condition at one or more times respectively corresponding to the one or more locations.

### BRIEF DESCRIPTION OF THE FIGURES

These and other aspects and features of the present implementations are depicted by way of example in the figures discussed herein. Present implementations can be directed to, but are not limited to, examples depicted in the figures discussed herein. Thus, this disclosure is not limited to any figure or portion thereof depicted or referenced herein, or any aspect described herein with respect to any figures depicted or referenced herein.

FIG. 1 depicts an example system, according to this disclosure.

FIG. 2 depicts an example flow architecture, according to this disclosure.

FIG. 3 depicts an example method of multi-model blending of probabilistic weather forecasts, according to this disclosure.

FIG. 4 depicts an example method of multi-model blending of probabilistic weather forecasts, according to this disclosure.

FIG. 5 depicts an example method of multi-model blending of probabilistic weather forecasts, according to this disclosure.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein. Further, this technical solution and the present implementations encompass present and future known equivalents to the known components referred to herein by way of description, illustration, or example.

Aspects of this disclosure are directed to a blender model having a machine learning architecture and configured to generate a forecast of a weather condition at a given location at a future time period, such as a time period between two weeks and one year from the forecast point. The forecast point can correspond to a present time at which the forecast is generated. For instance, aspects of the technical solutions can include a machine learning model trained to generate a forecast of weather conditions at a given location up to one year in advance. In an aspect, the technical solutions can train a blender model using machine learning to weight output of a plurality of probabilistic weather models, and to generate a weighted output of each of the probabilistic weather models with respect to various locations (e.g., grid points) of a geographical arca (e.g., a regional, state, continental, or a world map). The output can correspond to a probabilistic determination of likelihood of the weather condition at the location, based on the blending of the input probabilistic models according to the weights assigned by training via machine learning for a given location. The technical solutions can provide at least a technical improvement to generate accurate forecasts of weather conditions on a future date greater than two weeks in advance (e.g., from one or two months in advance up to a year, or longer than a year, in advance), including on a seasonal basis.

While various examples described herein refer to two or more weeks of advance forecast, the technical solutions of this disclosure are not limited to weather forecasting from only two weeks in advance. Rather, the technical solutions can provide a weather forecast for a lead time of one day or more in advance (e.g., between one day and two week or fourteen days), as well as two, three, four, six, nine, twelve or more than twelve months in advance. In an aspect, a machine learning model can be trained according to this technical solution to have a constant set of weights corresponding to a given forecast lead time, latitude, longitude, or season.

For example, a forecast configured for a particular month (e.g., June) of a given first year can include the same weights as a forecast configured for the same month (e.g., June) of a given second year, where the specified one or more months correspond to a given time duration or a season within a year. Thus, the technical solutions can provide technical improvements to increase the range of potential scenarios in which a machine learning model, combining or blending the outputs or operations of a plurality of probabilistic weather models, can deliver accurate long-range or short-range (e.g., less than two week or fourteen days) or longer time period forecasts.

In an example, the technology described herein provides a system that includes or utilizes a blending model. The blending model can be configured to combine or use probabilistic forecasts from a plurality of constituent models (e.g., multiple same or different weather model forecasts). These constituent models can be presented in any number of formats, including for example: (a) discrete trajectories of weather properties through perturbed ensemble member runs, sourced from Numerical Weather Prediction models or machine-learning-based weather emulator models, and (b) probabilistic representations from statistical or machine learning-type weather models, formatted as a quantile function (QF), cumulative distribution function (CDF), or probability distribution function (PDF). The technical solutions can provide a system that can be configured to standardize the model outputs from the constituent models into a common format, such as a quantile function or a set of categorical bins, which can be utilized for training purposes.

To create the training dataset, the system of the technical solutions can combine historical forecasts from each constituent model with corresponding truth data for the target weather property. For instance, the system can introduce each forecast to the blending model as a training sample, and the model can undergo training by adjusting the weights of the model to minimize a pre-selected loss function. The system can employ a gradient descent algorithm for the purposes of training, which can iteratively adjust weights for each mini-batch of forecast samples. The system can repeat this process over multiple cycles, or epochs, until the system does not observe any further decrease in the loss metric on an out-of-sample validation dataset.

The system can adjust, reconfigure or optimize the blending model to improve or enhance (e.g., maximize, minimize or conform to a selected range) one or more probabilistic performance metrics, such as the Continuous Ranked Probability Score (CRPS) for continuous scales or Binary Cross Entropy (BCE) for discrete categories. The process executed by the system can facilitate maintaining the consistency of the blended forecast, such as by avoiding quantile crossings and normalizing weights to sum to one.

The system can generate numerical weights for each constituent forecast model. These values can collectively sum to a particular value, such as the value of one. In some cases, the system uses constant weights over time. In some cases, the system can allow the weights to vary, such as by spatial grid point, forecast lead time, and season. The training process can adjust or optimize the weights under these conditions.

The system performs cross-validation to improve the model training and validation sequence. For example, a training set can be generated for each constituent model, utilizing cross-validated out-of-sample reforecast data for statistical or machine learning models and available reforecast data for physically-based numerical weather prediction models. This dataset can be further divided into training and validation sets in a k-fold scheme, allowing individual model training for each fold. These fold models then collectively produce a blended out-of-sample reforecast across the entire training dataset for validation. An additional separate test period can be withheld from all training folds, preserving an extra independent out-of-sample set throughout cross-validation.

In some implementations, the system can provide an operational version of the model in a production system by storing the trained model weights. To do so, the system can construct a similar pipeline of real-time constituent model forecast inputs to be processed by the trained model for ongoing predictions.

Technical advantages of the technical solutions described herein can include the capability to accept probabilistic forecast models as inputs and, in turn, generate a combined or an optimized probabilistic blended forecast. This can allow the technical solution described herein to accurately represent forecast uncertainty for sub-seasonal to seasonal (S2S) timescales, thereby enhancing the usability of the forecast for a wide range of decision-making applications.

Another technical advantage of aspects of the technical solutions described herein relates to the ability of the technical solution to assign independent weights to each constituent model in accordance with their variable historical accuracy. Depending on the implementation, the historical accuracy which may depend on forecast lead time, spatial location, and prevailing climate state. By dynamically adjusting the model weights in response to these factors, aspects of the technical solutions described herein can achieve superior forecast accuracy and performance compared to approaches that rely on fixed constituent model weights.

Yet another technical advantage of aspects of the technical solutions described herein can relate to providing a rigorous cross-validation protocol designed to maximize the available out-of-sample validation data for model evaluation. This methodology generates reliable information regarding the conditions under which the blended forecasting model exhibits strong accuracy and performance, thereby supporting more informed weather-related decision-making, action generation, and operations.

In some cases, the system can implement a single global blending model using a neural network architecture. This neural network can be configured to receive, as inputs, the spatial and temporal coordinates in addition to other predictive features relevant to the forecasting process. The neural network can be trained to output the blending weights at each grid point based on these input features. As a result, this approach can allow for the blending weights to vary in a non-linear manner for each forecast instance, thereby allowing the model to dynamically assign higher or lower weighting to individual constituent models in response to prevailing weather conditions or other relevant factors.

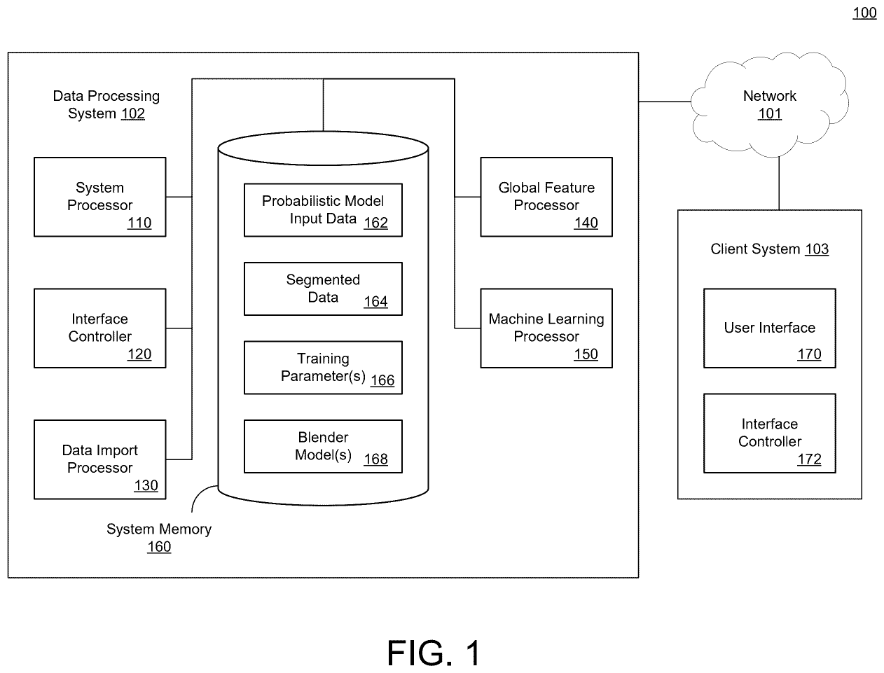

FIG. 1 depicts an example system 100, according to this disclosure. As illustrated by way of example in FIG. 1, a system 100 can include at least a network 101, a data processing system 102, and a client system 103. The client system 103 can include a user interface 170, and an interface controller 172. For example, the interface controller 172 can facilitate or effect communication with the data processing system 102 via the interface controller 120. For example, the user interface 170 can present graphical user interface elements corresponding to output of a blender model as discussed herein. For example, the user interface 170 can present graphical user interface elements compositing or overlaying output of a plurality of blender models as discussed herein.

The network 101 can include any type or form of network. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks 101. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the ATM (Asynchronous Transfer Mode) technique, the SONET (Synchronous Optical Networking) protocol, or the SD (Synchronous Digital Hierarchy) protocol. The ‘TCP/IP Internet protocol suite can include application layer, transport layer, Internet layer (including, e.g., IPv6), or the link layer. The network 101 can include a type of a broadcast network, a telecommunications network, a data communication network, or a computer network.

The data processing system 102 can include a physical (e.g., hardware) computer system operatively coupled or that can be coupled with one or more components of the system 100, either directly or directly through an intermediate computing device or system. The data processing system 102 can include a virtual computing system, an operating system, and a communication bus to effect communication and processing. The data processing system 102 can include one or more of system processors 110, interface controllers 120, data import processors 130, global feature processors 140, machine learning processors 150, and system memories 160.

The system processor 110 can execute one or more instructions associated with the system 100. The system processor 110 can include an electronic processor, an integrated circuit, or the like including one or more of digital logic, analog logic, digital sensors, analog sensors, communication buses, volatile memory, nonvolatile memory, and the like. The system processor 110 can include, but is not limited to, at least one microcontroller unit (MCU), microprocessor unit (MPU), central processing unit (CPU), graphics processing unit (GPU), physics processing unit (PPU), embedded controller (EC), or the like. The system processor 110 can include a memory operable to store or storing one or more instructions for operating components of the system processor 110 and operating components operably coupled to the system processor 110. For example, the one or more instructions can include one or more of firmware, software, hardware, operating systems, embedded operating systems. The system processor 110 or the system 100 generally can include one or more communication bus controller to effect communication between the system processor 110 and the other elements of the system 100.

The data import processor 130 can import model outputs from one or more probabilistic models, and can receive the model outputs from the interface controller 120. For example, the data import processor 130 can obtain one or more data sets and can generate one or more subsets that are discussed herein. For example, the data import processor 130 can include one or more data processing or preprocessing components to identify a target property and to generate, modify, restructure, or any combination thereof, a data set from a probabilistic model to be compatible with a machine learning system, including, but not limited to, the global feature processor 140. For example, the data import processor 130 can provide one or more correlated data subsets to the global feature processor 140 or the machine learning processor 150.

For example, the data import processor 130 can segment a first training data set, obtained from the probabilistic model input data storage 162, into multiple second training data sets. Each second training data set can include subsets from a first output received from a first probabilistic model and a second output from a second probabilistic model. For example, the data import processor 130 may divide the forecast data by location or by seasonal interval. For instance, this can produce subsets where forecasts from both probabilistic models correspond to the same place and time. As one example, outputs from a numerical weather prediction model and a statistical weather model for daily high temperature at a particular location may be combined into a segment for that location and date range. The segmented data sets can then be stored in the segmented data storage 164 and provided to the global feature processor 140 or the machine learning processor 150 for further analysis and model training.

The data import processor 130 can be configured to obtain a runtime data set during forecast operations. This runtime data set can include a first output from a first probabilistic model and a second output from a second probabilistic model, received either in real-time or from previously stored forecast data. For instance, the data import processor 130 may retrieve a probabilistic temperature forecast from a numerical weather prediction model and a corresponding probabilistic forecast from a statistical weather model for the same location and forecast period. The combined runtime data set can be pre-processed or formatted as needed and provided to the machine learning processor 150 for further analysis.

In some instances, the data import processor 130 can correlate each subset with ground truth data for the relevant weather condition. For example, the data import processor 130 may match forecasts from the probabilistic models with actual observed values for temperature or precipitation sourced from historical records. This can result in each training subset including both probabilistic forecasts and the corresponding observed outcome for a given location and time. These improved subsets can then be used by the global feature processor 140 to extract features or target properties, supporting the training of the blender model within the machine learning processor 150.

The global feature processor 140 can select and provide one or more parameters to the machine learning processor 150 that correspond to a target property for blending of a plurality of probabilistic models as discussed herein. For example, the global feature processor 140 can identify that a target property corresponds to a given feature in the data set input or the correlated subsets of the data set input. In response, the global feature processor 140 can obtain or select at one of a control parameter and a consistency property corresponding to the target property. For example, the global feature processor 140 can identify a feature for a target property corresponding to a daily high temperature, and can select a control parameter indicative of a threshold of alignment with a temperature value. For example, the threshold of alignment can correspond to a maximum permissible deviation (e.g., 0.50%), but is not limited thereto. For example, the threshold of alignment can correspond to a maximum number of iterations or epochs, but is not limited thereto. For example, the control parameter can correspond to a loss function to be minimized over a plurality of iterations, and the threshold of alignment can indicate a satisfaction of a control parameters with respect to a loss function (e.g., a local or absolute minimum of deviation) or a timeout (e.g., maximum number of epochs).

The global feature processor 140 can generate a control parameter indicative of alignment of the machine learning model with one or more of the second training data sets. For example, the control parameter may comprise a loss function value, such as the continuous ranked probability score, which can be calculated over model predictions and observations in the validation data. For example, the control parameter can represent the calibration of probabilistic forecasts, which can be measured across different locations or forecast periods. In some cases, the control parameter may indicate the number of training epochs completed or the degree to which consistency constraints, like non-crossing quantiles, are satisfied. This control parameter can be used to assess training progress and determine whether model performance meets a predefined threshold before updating or deploying the trained blender model.

The machine learning processor 150 can include or execute an operation to train a machine learning model, or execute a trained machine learning model. For example, the machine learning processor 150 can obtain one or more data sets or correlated subsets from the data import processor 130. For example, the machine learning processor 150 can obtain one or more features or properties based on a selection or identification of the features or properties by the global feature processor 140. In an aspect, the machine learning processor 150 is structured to receive input data and input features structured according to one or more probabilistic models or type of probabilistic models. In an aspect, the machine learning processor 150 is structured to generate, by the trained machine learning model, a probabilistic output for a target property, where the target property is a target feature among a plurality of features structured according to one or more probabilistic models or type of probabilistic models at least as discussed herein.

For example, the machine learning processor 150 can modify, for each of the second training data sets received from the segmented data storage 164, one or more weights of a machine learning model. Each second training data set can include a first point indicating the value of a weather condition at a specific location and a second point indicating the value of the weather condition at a specific time for that location. For example, the machine learning processor 150 may update the blending weights for each constituent probabilistic model based on differences between the predicted and actual values at particular grid points and forecast lead times. These weights can be adjusted iteratively through a training process, such as gradient descent, to improve the accuracy and calibration of the blender model. The updated weights can then be stored for use in generating future probabilistic forecasts for various locations and times.

For example, the machine learning processor 150 can provide the trained machine learning model when the control parameter from the global feature processor 140 satisfies a required threshold. For example, if the loss function value calculated over the validation data falls below a preset target, the machine learning processor 150 can finalize and deploy the trained blender model. As another example, the machine learning processor 150 may confirm that consistency constraints, such as weight normalization and non-crossing quantile levels, are satisfied before making the model available for generating forecasts. When the threshold condition is met, the machine learning processor 150 can use the saved weights to generate weighted outputs from the first probabilistic model and the second probabilistic model at each required location and forecast time, supporting accurate and consistent probabilistic weather predictions.

The machine learning processor 150 can use a trained machine learning model, with stored weights from previous training, to generate a weighted output using the runtime data set from the data import processor 130. The processor inputs the outputs from the first and second probabilistic models and applies the model's learned weights, which correspond to relevant training points for the specified location and forecast time. For example, the machine learning processor 150 may weigh the temperature forecasts from both models differently depending on geographic region or forecast lead time, such as based on historical model performance. The result can be a combined probabilistic forecast for the chosen location and time, generated according to the best-performing model weights for that context.

The system memory 160 can store data associated with the system 100. The system memory 160 can include one or more hardware memory devices to store binary data, digital data, or the like. The system memory 160 can include one or more electrical components, electronic components, programmable electronic components, reprogrammable electronic components, integrated circuits, semiconductor devices, flip flops, arithmetic units, or the like. The system memory 160 can include at least one of a non-volatile memory device, a solid-state memory device, a flash memory device, or a NAND memory device. The system memory 160 can include one or more addressable memory regions disposed on one or more physical memory arrays. A physical memory array can include a NAND gate array disposed on, for example, at least one of a particular semiconductor device, integrated circuit device, and printed circuit board device. The system memory 160 can include a probabilistic model input data storage 162, a segmented data storage 164, training parameters storage 166, and blender models storage 168.

The probabilistic model input data storage 162 can store the data set as discussed herein. For example, the probabilistic model input data storage 162 is not limited to any given type or number, and can store input data corresponding to a plurality of target properties at least as discussed herein (e.g., daily high temperature, daily low temperature, humidity, frost, extreme weather events). Thus, the probabilistic model input data storage 162 can support determination of a plurality of target properties as discussed herein. For example, the probabilistic model input data storage 162 can store or buffer live data corresponding to output from one or more probabilistic models. The segmented data storage 164 can store correlated subsets of the data set as discussed herein. For example, the segmented data storage 164 is not limited to any given type or number, and can store input data or correlated subsets corresponding to a plurality of target properties at least as discussed herein. Thus, the segmented data storage 164 can support determination of a plurality of target properties as discussed herein. For example, the segmented data storage 164 can store or buffer correlated subsets of live data corresponding to output from one or more probabilistic models.

The training parameters storage 166 can store one or more parameters associated with training a machine learning model according to probabilistic input data as discussed herein. For example, the training parameters storage 166 can store one or more control parameters and one or more consistency properties as discussed herein. The blender models storage 168 can store one or more blender models as discussed herein. For example, a blender model corresponds to a trained machine learning model as discussed herein. The blender models storage 168 can store a plurality of blender models each corresponding to a respective target property. For example, the blender models storage 168 can store a first blender model corresponding to forecasting a daily high temperature six months in advance, a second blender model corresponding to forecasting a daily low temperature six months in advance, and a third blender model corresponding to forecasting a daily humidity six months in advance. The blender models storage 168 can store a plurality of blender models each corresponding to a respective set of probabilistic models. For example, each blender model can be trained on or operate to generate live data on varying subsets of available probabilistic model input. For example, a fist blender model can include National Oceanic and Atmospheric Administration (NOAA) data, and a second blender model can exclude NOAA data.

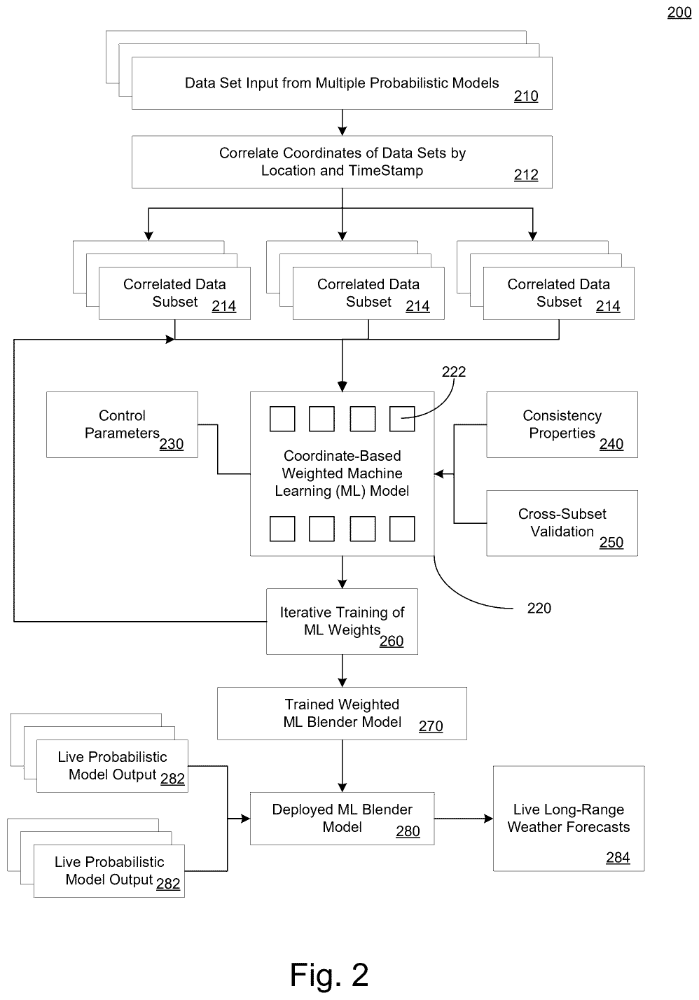

FIG. 2 depicts an example flow architecture, according to this disclosure. As illustrated by way of example in FIG. 2, a flow architecture 200 can include data set input from multiple probabilistic models 210 and correlated data subsets 214. For example, the flow architecture 200 can correlate coordinates of data sets by location and timestamp 220, can include a coordinate-based weighted machine learning (ML) model 220, control parameters 230, consistency properties 240, can perform a cross-subset validation 250 and an iterative training of ML weights 260 to obtain a trained weighted ML blender model 270. For example, the flow architecture 200 can provide a deployed ML blender model 280 to generate live probabilistic model outputs 282 and live long-range weather forecasts 284.

The data set input from multiple probabilistic models 210 can correspond to output of multiple probabilistic models as discussed herein. For example, the data set input from multiple probabilistic models 210 can include output of at least a first probabilistic model and a second probabilistic model. In an aspect, the first probabilistic model generates output structured according to at least one of a quantile, a cumulative distribution, or a probability distribution. For example, each of a quantile, a cumulative distribution, or a probability distribution types can correspond to a probabilistic configuration of a probabilistic model. For example, the first probabilistic model has a first probabilistic configuration, and the second probabilistic model has a second probabilistic configuration distinct from the first probabilistic configuration. In an aspect, the first probabilistic model corresponds to at least one of a numerical weather prediction model, a weather emulator model, or a statistical weather model. In an aspect, the second probabilistic model corresponds to at least one of a numerical weather prediction model, a weather emulator model, or a statistical weather model. In an aspect, the second probabilistic model generates output structured according to at least one of a quantile, a cumulative distribution, or a probability distribution.

The correlated data subsets 214 can each correspond to a correlated subset of data input from a probabilistic model, at least as discussed herein. In an aspect, the system can correlate, into the first training data set, a third output corresponding to ground truth for the weather condition, the third output can include one or more values indicative of the weather condition. For example, the data import processor 130 can correlate coordinates of data sets 212 by location and timestamp. The correlating coordinates of data sets 212 by location and timestamp can include use of ML model weights 222. In an aspect, the system can provide corresponding ones of the plurality of second training data sets sequentially to the machine learning model over one or more iterations to modify the one or more ML model weights 222 over the one or more iterations.

In an aspect, the system can modify, for each of the subsets, the one or more ML model weights 222 according to one or more consistency properties that constrain modification of the one or more weights. The machine learning processor 150 can generate or train the coordinate-based weighted machine learning (ML) model 220. The coordinate-based weighted machine learning (ML) model 220 can include ML model weights 222. In an aspect, the machine learning processor 150 can modify, for each of the subsets, the one or more ML model weights 222 independently with respect to a plurality of weather properties each indicative of corresponding physical properties, where the weather properties each correspond to at least one of location, forecast lead time, or season.

The control parameters 230 can include a control parameter as discussed herein, and can be obtained from the training parameters storage 166. In an aspect, the system can determine that the control parameter satisfies the threshold according to a target property indicative of the weather condition, the target property corresponding to a feature of the machine learning model. In an aspect, the one or more weights are provided responsive to a control parameter satisfying a threshold indicative of a level of alignment with a training data set can include the one or more first training points and the one or more second training points. In an aspect, a control parameter can be seasonally adjusted, to align with values or features of weather-related probabilistic data according to segments associated with seasons. For example, a control parameter can have a first value or range of values for timestamps aligned with one or more predetermined summer months, and a second value or range of values for timestamps aligned with one or more predetermined winter months. For example, a control parameter can have a first value or range of values for timestamps aligned with one or more detected local maxima (e.g., values indicative of summer months), and a second value or range of values for timestamps aligned with one or more detected local minima (e.g., values indicative of winter months). The consistency properties 240 can include a consistency property as discussed herein, and can be obtained from the training parameters storage 166. In an aspect, the one or more consistency properties constrain modification of the one or more weights for each of the subsets. In an aspect, the consistency properties are structured to enforce non-crossing of quantile levels. In an aspect, the consistency properties are structured to enforce normalization of each of the one or more weights to aggregate to a predetermined scalar value.

The machine learning processor 150 can perform cross-subset validation 250. For example, the machine learning processor 150 can validate the coordinate-based weighted ML model 220 according to one or more consistency properties as discussed herein. In an aspect, the machine learning processor 150 can perform the iterative training of ML weights 260, by looping training of the coordinate-based weighted ML model 220 in view of one or more of the control parameters 230, and one or more of the consistency properties 240. For example, the machine learning processor 150 can modify one or more of the weights 222 according to a control parameter 230, and can validate output of the coordinate-based weighted machine learning (ML) model 220 according to the consistency properties 240 in each iteration. For example, the machine learning processor 150 can keep or modify the weights 222 as modified or generated in a given iteration based on whether the weights satisfy the consistency properties 240.

The trained weighted ML blender model 270 can correspond to an output of the machine learning processor 150 including the coordinate-based weighted ML model 220 and the weights 222 that satisfy the consistency properties 240. The deployed ML blender model 280 can correspond at least partially in one or more of structure and operation to an instance of the trained weighted ML blender model 270 that is configured to execute at runtime to generate output according to the weights 222 of the coordinate-based weighted ML model 220. The live probabilistic model outputs 282 can be provided as input to the deployed ML blender model 280 by the machine learning processor 150 during runtime of the deployed ML blender model 280, to generate one or more live long-range weather forecasts 284 according to a weather condition represented by a target property as discussed herein. In an aspect, the weather condition corresponds to a forecast lead time greater than two weeks. The live long-range weather forecasts 284 can include one or more probabilistic outputs as discussed herein that each correspond to a given target property.

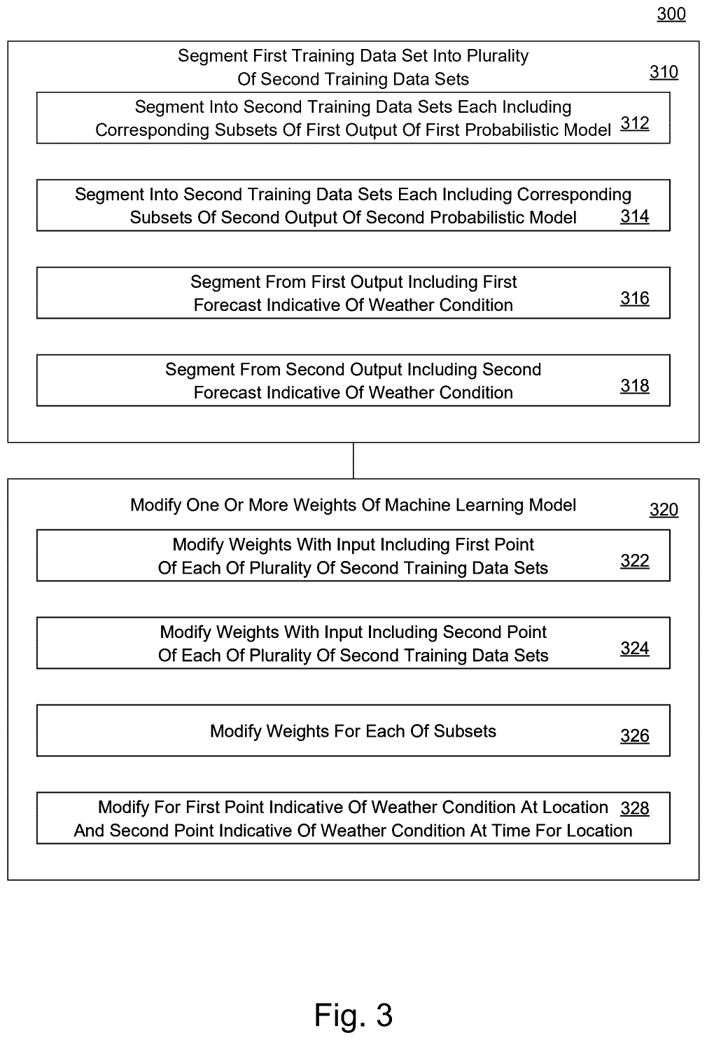

FIG. 3 depicts an example method of multi-model blending of probabilistic weather forecasts, according to this disclosure. At least the system 100 or the flow architecture 200 can perform method 300. For example, the method 300 can be implemented using one or more processors executing instructions that are stored in memory of the system. The instructions, upon execution by the one or more processors, can cause the one or more processors to implement any of the operations 310-328 of the method 300 in any sequence or arrangement.

At 310, the method 300 can segment a first training data set into a plurality of second training data sets. The method 300 can implement this using operations 312-318. For example, at 312, the method 300 can segment into second training data sets each including corresponding subsets of a first output of a first probabilistic model. At 314, the method 300 can segment into second training data sets each including corresponding subsets of a second output of a second probabilistic model. At 316, the method 300 can segment from first output including a first forecast indicative of a weather condition. In an aspect, the weather condition corresponds to a forecast lead time greater than two weeks. At 318, the method 300 can segment from second output including a second forecast indicative of the weather condition.

In further discussion of operation 310, at 312, the method 300 can segment each of the plurality of second training data sets to include corresponding subsets from a first output of a first probabilistic model. For example, the method may organize output data from the first probabilistic model by forecast date or location, producing separate subsets that each contain only the relevant forecasts generated by the first model. These subsets can be used in further processing steps to support accurate model blending and analysis.

At 314, the method 300 can segment each of the plurality of second training data sets to include corresponding subsets from a second output of a second probabilistic model. For instance, the method may extract output from the second probabilistic model for each forecasted property and align these with the segments defined for the first model. This can allow that for every segment, the corresponding forecasts from both models are available for comparison or combination.

At 316, the method 300 can segment the first output so that each subset includes a first forecast indicative of a weather condition. For example, each subset may be constructed to contain the first model's probabilistic prediction of temperature, precipitation, or another weather attribute at a specific location or time. In some cases, the forecast can correspond to extended lead times, such as periods greater than two weeks.

At 318, the method 300 can segment the second output so that each subset includes a second forecast indicative of the weather condition. For example, the corresponding segment from the second probabilistic model may also provide a forecast for temperature or precipitation at the same place and time as the first model's output. This alignment can allow that both sets of forecasts relate to the same weather condition under consideration.

In an aspect, the first probabilistic model has a first probabilistic configuration, and the second probabilistic model has a second probabilistic configuration distinct from the first probabilistic configuration. In an aspect, the first probabilistic model corresponds to at least one of a numerical weather prediction model, a weather emulator model, or a statistical weather model, and the second probabilistic model corresponds to at least one of the numerical weather prediction model, the weather emulator model, or the statistical weather model. In an aspect, the method can include correlating, into the first training data set, a third output corresponding to ground truth for the weather condition, the third output can include one or more values indicative of the weather condition.

At 320, the method 300 can modify one or more weights of a machine learning model. At 322, the method 300 can modify the weights with input including a first point of each of the plurality of second training data sets. At 324, the method 300 can modify the weights with input including a second point of each of the plurality of second training data sets. At 326, the method 300 can modify the weights for each of the subsets.

In an aspect, the method can include modifying, for each of the subsets, the one or more weights according to one or more consistency properties that constrain modification of the one or more weights. In an aspect of the method 300, the consistency properties are structured to enforce non-crossing of quantile levels. In an aspect of the method 300, the consistency properties are structured to enforce normalization of each of the one or more weights to aggregate to a predetermined scalar value. In an aspect of the method 300, the one or more consistency properties constrain modification of the one or more weights for each of the subsets. At 328, the method 300 can modify the one or more weights for a first point indicative of the weather condition at a location and the second point indicative of the weather condition at a time for the location. In an aspect, the method can include modifying, for each of the subsets, the one or more weights independently with respect to a plurality of weather properties each indicative of corresponding physical properties, where the weather properties each correspond to at least one of location, forecast lead time, or season. In an aspect, the method can include providing corresponding ones of the plurality of second training data sets sequentially to the machine learning model over one or more iterations to modify the one or more weights over the one or more iterations.

At 322, the method 300 can modify the model weights using one or more inputs that include a first point from each of the second training data sets. For example, the first point may represent a value related to the forecasted weather condition at a specific location. The method can update the weights based on how closely the first probabilistic model's prediction at that point aligns with observed outcomes or targets.

At 324, the method 300 can modify the weights using input that includes a second point from each of the second training data sets. This second point may correspond to a value related to the forecasted weather condition at a particular time for the location in question. The method can further refine the model's weights by considering how well the second probabilistic model's prediction for that time matches actual values or targets.

At 326, the method 300 can modify the weights for each of the subsets independently. For example, the method may update the weights separately for different locations, times, or other groupings represented in the training data. This allows the machine learning model to learn optimal blending weights that are specific to particular segments or scenarios.

At 328, the method 300 can modify the weights for a first point that is indicative of the weather condition at a location and for a second point that is indicative of the weather condition at a time corresponding to that location. For instance, the machine learning model may use both spatial and temporal information from the training data to determine the most effective way to weigh the outputs of each probabilistic model, resulting in more or most accurate and context-aware weather forecasts.

In an aspect of the method 300, the first probabilistic model has a first probabilistic configuration, and the second probabilistic model has a second probabilistic configuration distinct from the first probabilistic configuration. In an aspect of the method 300, the first probabilistic model corresponds to at least one of a numerical weather prediction model, a weather emulator model, or a statistical weather model. In an aspect of the method 300, the second probabilistic model corresponds to at least one of a numerical weather prediction model, a weather emulator model, or a statistical weather model. In an aspect of the method 300, the first probabilistic model generates output structured according to at least one of a quantile, a cumulative distribution, or a probability distribution. In an aspect of the method 300, the second probabilistic model generates output structured according to at least one of a quantile, a cumulative distribution, or a probability distribution.

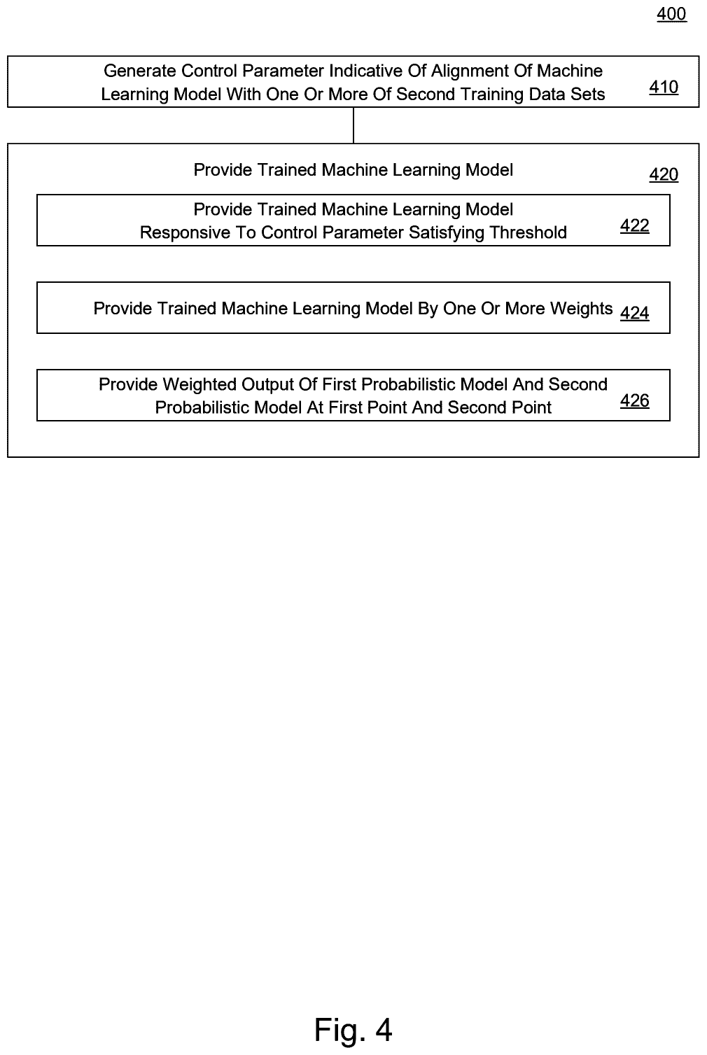

FIG. 4 depicts an example method of multi-model blending of probabilistic weather forecasts, according to this disclosure. At least the system 100 or the flow architecture 200 can perform method 400. For example, the method 400 can be implemented using one or more processors executing instructions that are stored in memory of the system. The instructions, upon execution by the one or more processors, can cause the one or more processors to implement any of the operations 410-426 of the method 400 in any sequence or arrangement.

At 410, the method 400 can generate a control parameter indicative of alignment of the machine learning model with one or more of the second training data sets. In an aspect, the method can include determining that the control parameter satisfies the threshold according to a target property indicative of the weather condition, the target property corresponding to a feature of the machine learning model.

At 420, the method 400 can provide the trained machine learning model. In an aspect of the method 400, the one or more weights are provided responsive to a control parameter satisfying a threshold indicative of a level of alignment with a training data set can include the one or more first training points and the one or more second training points. At 422, the method 400 can provide the trained machine learning model responsive to the control parameter satisfying the threshold. At 424, the method 400 can provide the trained machine learning model according to the one or more weights. At 426, the method 400 can provide a weighted output of the first probabilistic model and the second probabilistic model at the first point and the second point.

At 422, the method 400 can provide the trained machine learning model in response to the control parameter satisfying a threshold. The threshold can represent a specific value or condition, such as the loss function reaching a minimum target value, the model achieving a continuous ranked probability score (CRPS) below a set benchmark, or the validation error remaining within a predefined margin for a given number of consecutive epochs. For example, once the model achieves a predetermined level of accuracy or consistency on the training or validation data, the method can make the trained blender model available for use in real-time or operational forecasting scenarios.

At 424, the method 400 can provide the trained machine learning model in accordance with the one or more learned weights. The machine learning model can include weights optimized during training, which can be specific to different forecast contexts, such as lead time, location, or season. Using these weights, the method can allow that forecasts generated by the model to reflect the most desired combination of constituent models for any given scenario.

At 426, the method 400 can provide a weighted output of the first probabilistic model and the second probabilistic model at the first point and the second point. For example, the method can apply the learned blending weights to real-time forecasts from each constituent model and produce an aggregate probabilistic forecast for a specified location (first point) and forecast time (second point). The resulting forecast can take advantage of the strengths of each individual model, as captured by the adaptive weighting and the output can include a combination of the provided constituent outputs.

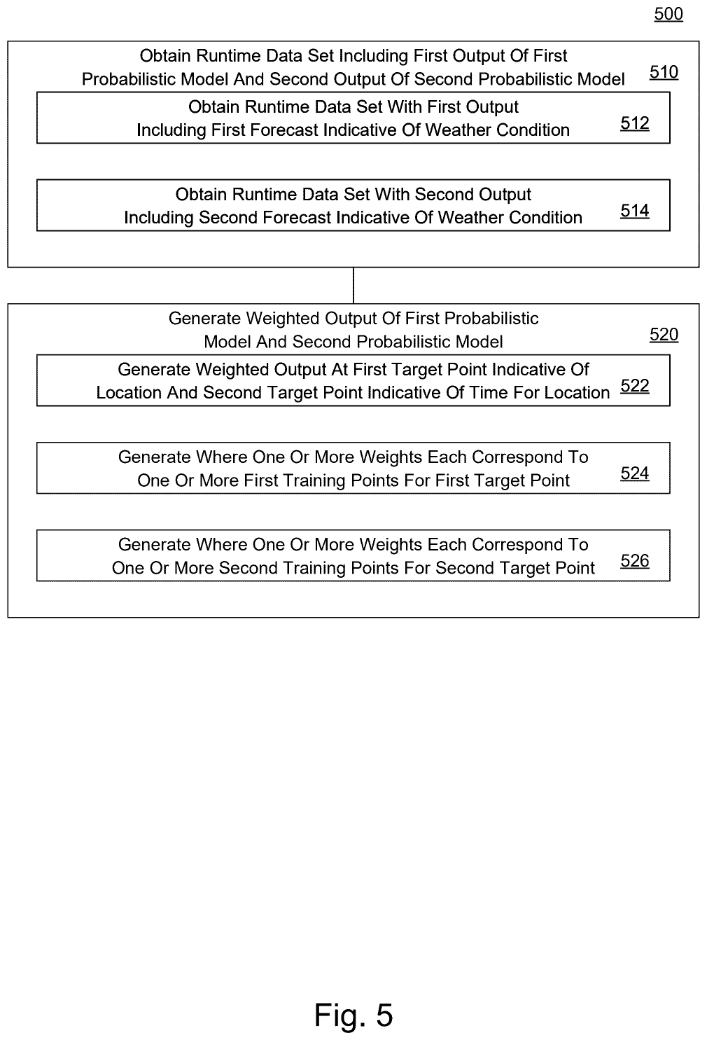

FIG. 5 depicts an example method of multi-model blending of probabilistic weather forecasts, according to this disclosure. At least the system 100 or the flow architecture 200 can perform method 500. For example, the method 500 can be implemented using one or more processors executing instructions that are stored in memory of the system. The instructions, upon execution by the one or more processors, can cause the one or more processors to implement any of the operations 510-526 of the method 500 in any sequence or arrangement.

At 510, the method 500 can obtain a runtime data set including a first output of a first probabilistic model and a second output of a second probabilistic model. For example, the method may receive real-time forecast data from two different weather prediction systems, such as a global numerical weather prediction model and a statistical postprocessing model. In some cases, these outputs may be retrieved from remote servers or local data storage.

At 512, the method 500 can obtain the runtime data set with the first output including a first forecast indicative of the weather condition. For example, the first output may provide a probability distribution of daily maximum temperature for a specific city seven days in the future. The first forecast may use a quantile or cumulative distribution representation as produced by the first probabilistic model.

At 514, the method 500 can obtain the runtime data set with the second output including a second forecast indicative of the weather condition. For example, the second output may include a forecast for the same target variable and location, but generated using a different prediction method or data source. The second model's forecast may use a probability distribution function or ensemble-based representation for the weather condition.

At 520, the method 500 can generate a weighted output of the first probabilistic model and the second probabilistic model. For example, the method may combine the probabilistic forecasts from both models using weights learned during training. This can result in a blended probability distribution that more accurately reflect forecast uncertainty than any one of the constituent models individually.

At 522, the method 500 can generate the weighted output at a first target point indicative of a location and a second target point indicative of a time for the location. For example, the method may produce a forecast for temperature at a specified city (the first target point) for a date three weeks in the future (the second target point). The blended forecast can be tailored to the given location or forecast time.

At 524, the method 500 can generate where the one or more weights each correspond to one or more first training points for the first target point. For example, the method can apply weights that were optimized based on historical forecast performance for that particular city or latitude/longitude pair. This allows the blended forecast to account for local conditions reflected in previous training data.

At 526, the method 500 can generate where the one or more weights each correspond to one or more second training points for the second target point. For example, the method may apply weights determined by model skill for the given forecast lead time, such as three weeks or three months ahead, as established in the training phase. This can facilitate that the blended forecast is appropriately calibrated for the temporal characteristics of the prediction.

In an aspect of the methods 300-500, the first probabilistic model has a first probabilistic configuration, and the second probabilistic model has a second probabilistic configuration distinct from the first probabilistic configuration. In an aspect of the methods 300-500, the first probabilistic model corresponds to at least one of a numerical weather prediction model, a weather emulator model, or a statistical weather model, and the second probabilistic model corresponds to at least one of the numerical weather prediction model, the weather emulator model, or the statistical weather model.

Having now described some illustrative implementations, the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations.

The phraseology and terminology used herein is for the purpose of description and should not be regarded as limiting. The use of “including,” “comprising,” “having,” “containing,” “involving,” “characterized by,” “characterized in that,” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both “A” and ‘B’. Such references used in conjunction with “comprising” or other open terminology can include additional items. References to “is” or “are” may be construed as nonlimiting to the implementation or action referenced in connection with that term. The terms “is” or “are” or any tense or derivative thereof, are interchangeable and synonymous with “can be” as used herein, unless stated otherwise herein.

Directional indicators depicted herein are example directions to facilitate understanding of the examples discussed herein, and are not limited to the directional indicators depicted herein. Any directional indicator depicted herein can be modified to the reverse direction, or can be modified to include both the depicted direction and a direction reverse to the depicted direction, unless stated otherwise herein. While operations are depicted in the drawings in a particular order, such operations are not required to be performed in the particular order shown or in sequential order, and all illustrated operations are not required to be performed. Actions described herein can be performed in a different order. Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any clam elements.

Scope of the systems and methods described herein is thus indicated by the appended claims, rather than the foregoing description. The scope of the claims includes equivalents to the meaning and scope of the appended claims.

1. A system, comprising:
one or more processors, coupled with memory, to:
segment a first training data set into a plurality of second training data sets each including corresponding subsets of a first output of a first probabilistic model and a second output of a second probabilistic model, the first output including a first forecast indicative of a weather condition, and the second output including a second forecast indicative of the weather condition;
modify, for each of the subsets, one or more weights of a machine learning model with input including a first point of each of the plurality of second training data sets and a second point of each of the plurality of second training data sets, the first point indicative of the weather condition at a location, and the second point indicative of the weather condition at a time corresponding to the location;
generate a control parameter indicative of alignment of the machine learning model with one or more of the plurality of second training data sets; and
provide, responsive to the control parameter satisfying a threshold indicative of a level of alignment with the plurality of second training data sets, the machine learning model trained to generate, according to the one or more weights, a weighted output of the first probabilistic model and the second probabilistic model at the first point and the second point.

2. The system of claim 1, comprising the one or more processors to:
determine that the control parameter satisfies the threshold according to a target property indicative of the weather condition, the target property corresponding to a feature of the machine learning model.

3. The system of claim 1, comprising the one or more processors to:
modify, for each of the subsets, the one or more weights independently with respect to a plurality of weather properties each indicative of corresponding physical properties, wherein the weather properties each correspond to at least one of location, forecast lead time, or season.

4. The system of claim 1, wherein the weather condition corresponds to a forecast lead time greater than two weeks.

5. The system of claim 1, wherein the first probabilistic model has a first probabilistic configuration, and the second probabilistic model has a second probabilistic configuration distinct from the first probabilistic configuration.

6. The system of claim 5, wherein the first probabilistic model corresponds to at least one of a numerical weather prediction model, a weather emulator model, or a statistical weather model.

7. The system of claim 5, wherein the second probabilistic model corresponds to at least one of a numerical weather prediction model, a weather emulator model, or a statistical weather model.

8. The system of claim 5, wherein the first probabilistic model generates output structured according to at least one of a quantile, a cumulative distribution, or a probability distribution.

9. The system of claim 5, wherein the second probabilistic model generates output structured according to at least one of a quantile, a cumulative distribution, or a probability distribution.

10. The system of claim 1, comprising the one or more processors to:
correlate, into the first training data set, a third output corresponding to ground truth for the weather condition, the third output including one or more values indicative of the weather condition.

11. The system of claim 1, comprising the one or more processors to:
provide corresponding ones of the plurality of second training data sets sequentially to the machine learning model over one or more iterations to modify the one or more weights over the one or more iterations.

12. The system of claim 1, comprising the one or more processors to:
modify, for each of the subsets, the one or more weights according to one or more consistency properties that constrain modification of the one or more weights.

13. The system of claim 12, wherein the consistency properties are structured to enforce non-crossing of quantile levels.

14. The system of claim 12, wherein the consistency properties are structured to enforce normalization of each of the one or more weights to aggregate to a predetermined scalar value.

15. The system of claim 12, wherein the one or more consistency properties constrain modification of the one or more weights for each of the subsets.

16.-20. (Canceled)

21. A method, comprising:
segmenting a first training data set into a plurality of second training data sets each including corresponding subsets of a first output of a first probabilistic model and a second output of a second probabilistic model, the first output including a first forecast indicative of a weather condition, and the second output including a second forecast indicative of the weather condition;
modifying, for each of the subsets, one or more weights of a machine learning model with input including a first point of each of the plurality of second training data sets and a second point of each of the plurality of second training data sets, the first point indicative of the weather condition at a location, and the second point indicative of the weather condition at a time corresponding to the location;
generating a control parameter indicative of alignment of the machine learning model with one or more of the plurality of second training data sets; and
providing, responsive to the control parameter satisfying a threshold indicative of a level of alignment with the plurality of second training data sets, the machine learning model trained to generate, according to the one or more weights, a weighted output of the first probabilistic model and the second probabilistic model at the first point and the second point.

22. The method of claim 21, further comprising:
determining that the control parameter satisfies the threshold according to a target property indicative of the weather condition, the target property corresponding to a feature of the machine learning model.

23. The method of claim 21, further comprising:
modifying, for each of the subsets, the one or more weights independently with respect to a plurality of weather properties each indicative of corresponding physical properties, wherein the weather properties each correspond to at least one of location, forecast lead time, or season.

24. The method of claim 21, wherein the weather condition corresponds to a forecast lead time greater than two weeks.

25. The method of claim 21. wherein the first probabilistic model has a first probabilistic configuration. and the second probabilistic model has a second probabilistic configuration distinct from the first probabilistic configuration.

26.-40. (Canceled)
